(19) United States
(12) Patent Application Publication
(10) Pub. No.: US 2025/0303833 A1
(43) Pub. Date: Oct. 2, 2025

(54) SIDE DOOR STRUCTURE

(71) Applicant: SUBARU CORPORATION, Tokyo (JP)

(72) Inventors: Kazuhiro FUKAMACHI, Tokyo (JP); Mitsuhiro IWAMOTO, Tokyo (JP)

(73) Assignee: SUBARU CORPORATION, Tokyo (JP)

(21) Appl. No.: 19/084,275

(22) Filed: Mar. 19, 2025

(30) Foreign Application Priority Data
Mar. 26, 2024 (JP) 2024-050382

(51) Int. Cl. B60J 5/04; B60L 50/60; B60R 13/07; B62D 21/15; B62D 25/02; H01M 50/242; H01M 50/249; H01M 50/691

(52) U.S. Cl. CPC B60J 5/0461; B60J 5/0413; B60J 5/0415; B60J 5/0427; B60J 5/0437; B60L 50/66; B60R 13/07; H01M 50/242; H01M 50/249; H01M 50/691; B62D 21/157; B62D 25/025; H01M 2220/20

(57) ABSTRACT

A side door structure includes an inner panel, an outer panel, a drain hole, an impact absorbing member, and a fixing member. The inner panel covers a vehicle-widthwise outer side of a side sill. The outer panel faces the inner panel and constitutes a side door together with the inner panel. The drain hole is provided in a lower end part of the inner panel and formed to drain rainwater entering the inside of the side door. The impact absorbing member is disposed inside the side door and extends in a front-rear direction of a vehicle body. The fixing member fixes the impact absorbing member to the inner panel at a position higher than a position facing the side sill. The fixing member is set to have a fixing strength at which the impact absorbing member is releasable upon input of an impact load of a predetermined load or more.

### CROSS-REFERENCE TO RELATED APPLICATIONS

The present application claims priority from Japanese Patent Application No. 2024-050382 filed on Mar. 26, 2024, the entire contents of which are hereby incorporated by reference.

### BACKGROUND OF THE INVENTION

### Field of the Invention

The present invention relates to a side door structure including an impact absorbing member that absorbs impact energy generated upon a collision or the like.

### Description of Background Art

Japanese Unexamined Patent Application Publication (JP-A) No. 2019-25935 describes a side door structure in which an impact absorbing member is disposed in the inside of a side door. The entire contents of this publication are hereby incorporated by reference.

### SUMMARY OF THE INVENTION

According to one aspect of the present invention, a side door structure includes an inner panel covering a vehicle-widthwise outer side of a side sill extending in a vehicle body front-rear direction of a vehicle, an outer panel joined to the inner panel at an edge part of the outer panel and constituting a side door of the vehicle together with the inner panel, an impact absorbing member disposed in an internal space of the side door and extending in the vehicle body front-rear direction, and a fixing member fixing the impact absorbing member to the inner panel at a position higher than a position facing the side sill. The inner panel has a drain hole formed in a lower end part of the inner panel and configured to drain rainwater entering the internal space of the side door from an outside of the vehicle, and the fixing member fixes the impact absorbing member to the inner panel at a fixing strength at which the impact absorbing member is releasable upon input of an impact load greater than or equal to a predetermined load to the side door.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a perspective view of a vehicle;

FIG. 2 is a perspective view illustrating a side door in an open position;

FIG. 3 is a cross-sectional view taken along line III-III of FIG. 1;

FIG. 4 is a side view illustrating a state of an inside of the side door;

FIG. 5 is an exploded enlarged view illustrating a fixing structure for fixing an impact absorbing member to a bracket;

FIG. 6 is a cross-sectional view illustrating a state in which the impact absorbing member falls downward upon input of an impact load greater than or equal to a predetermined load;

FIG. 7 is a perspective view illustrating a collision state of the impact absorbing member and the side sill at an initial stage of a pole side collision after the impact absorbing member has fallen; and

FIG. 8 is a perspective view illustrating a collision state of the impact absorbing member and the side sill at a final stage of the pole side collision after the impact absorbing member has fallen.

### DETAILED DESCRIPTION OF THE EMBODIMENTS

Embodiments will now be described with reference to the accompanying drawings, wherein like reference numerals designate corresponding or identical elements throughout the various drawings.

In the drawings used in conjunction with the following description, a different scale size is used for each of components in order to allow each component to be illustrated in a recognizable size in the drawings. The “join” described in the following description means any joining method performed using a joining technique represented by melt joining, mechanical joining, or the like.

As an example of a vehicle body to which a side door structure according to the present embodiment is applied, a description will be given of a vehicle body structure of a vehicle 1 such as an electric vehicle or a hybrid vehicle in which a battery 9 is mounted under a floor.

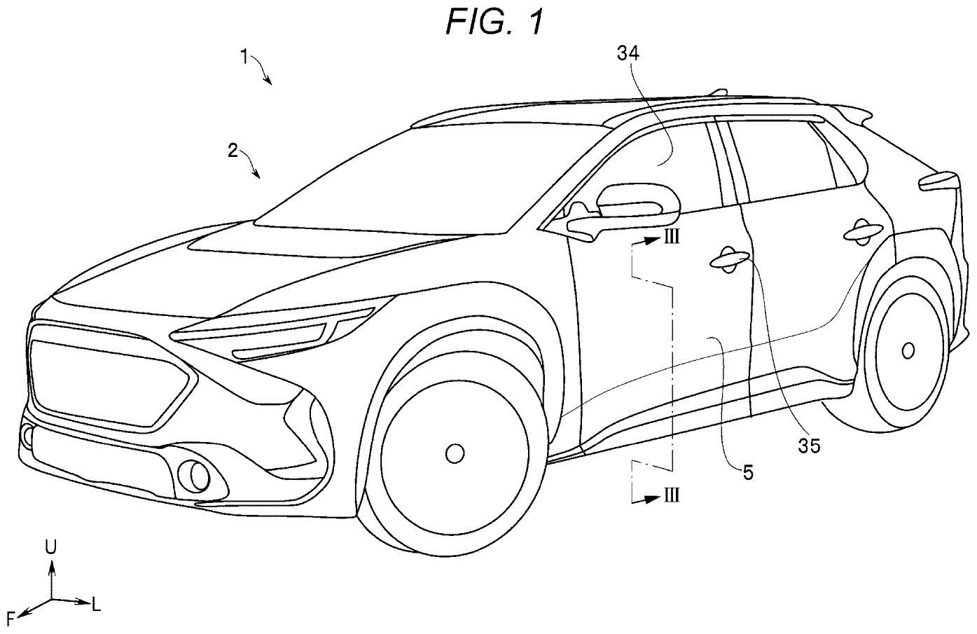

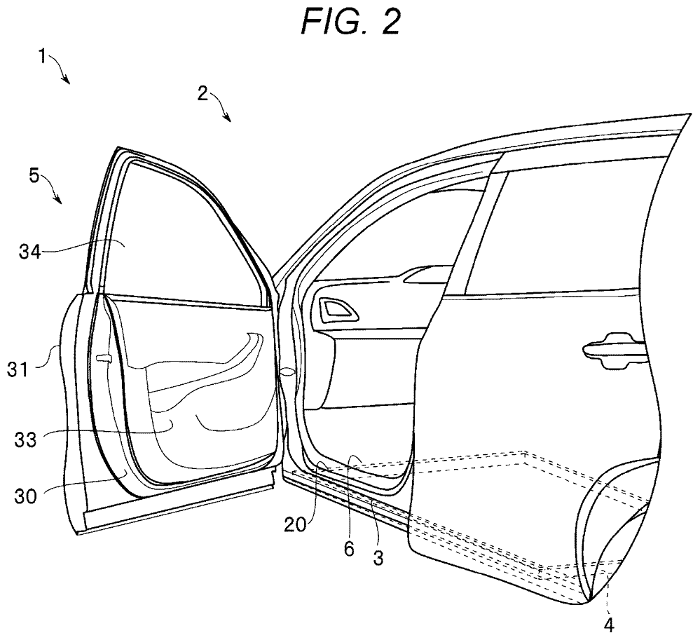

As illustrated in FIGS. 1 and 2, a vehicle body 2 of the vehicle 1 includes a side sill 3, a battery frame 4, and a front side door 5 (hereinafter, referred to as a side door 5).

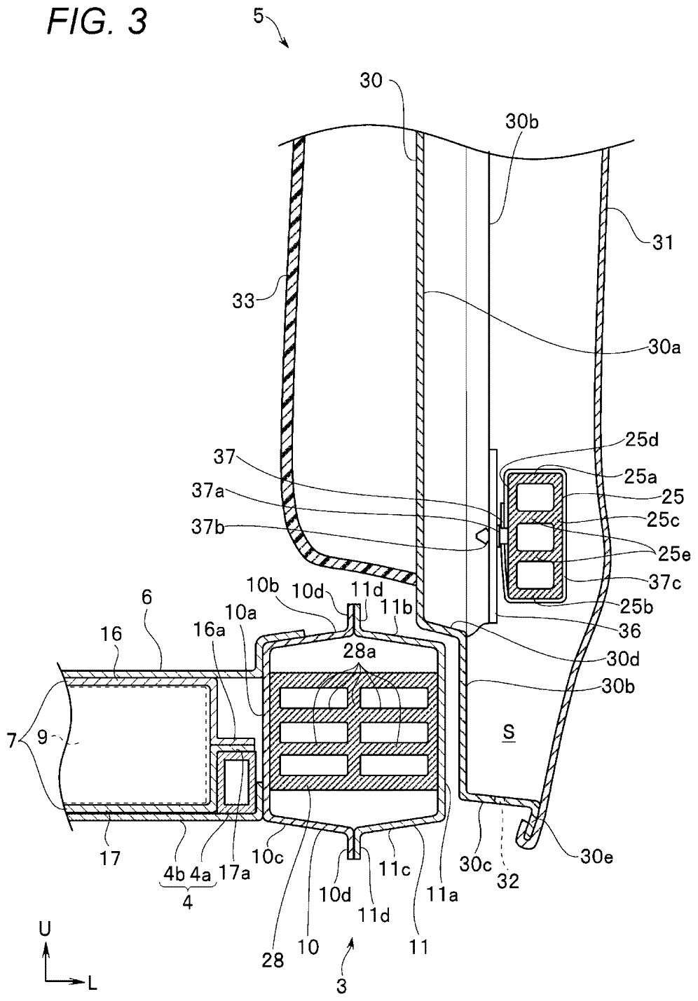

As illustrated in FIGS. 2 and 3, the side sill 3 is disposed on either side of a floor panel 6 constituting a bottom surface of a cabin. Furthermore, the side sill 3 extends along the floor panel 6 in a vehicle body front-rear direction. Such a side sill 3 is formed by pressing a sheet metal member made of a steel plate or the like.

As illustrated in FIG. 3, the side sill 3 includes an inner frame 10 and an outer frame 11.

The inner frame 10 has a substantially hat-shaped cross-sectional shape protruding vehicle-widthwise inward. Such an inner frame 10 has an inner wall part 10a, an upper wall part 10b, a lower wall part 10c, and upper and lower inner flanges 10d.

The inner wall part 10a extends in a vehicle body up-down direction.

The upper wall part 10b and the lower wall part 10c respectively extend vehicle-widthwise outward from both vehicle body up-down directional ends of the inner wall part 10a.

The upper and lower inner flanges 10d respectively extend in an up-down direction from vehicle-widthwise outer edge parts of the upper and lower wall parts 10b and 10c. The upper and lower inner flanges 10d each serve as a flange for joining the inner frame 10 to the outer frame 11.

The outer frame 11 has a substantially hat-shaped cross-sectional shape protruding vehicle-widthwise outward. The outer frame 11 is disposed at a position facing a vehicle-widthwise outer side of the inner frame 10. In one example, an opening part of the outer frame 11 is disposed facing an opening part of the inner frame 10.

The outer frame 11 thus disposed includes an outer wall part 11a, an upper wall part 11b, a lower wall part 11c, and upper and lower outer flanges 11d.

The outer wall part 11a is disposed at a position facing the inner wall part 10a.

The upper wall part 11b and the lower wall part 11c respectively extend vehicle-widthwise inward from both vehicle body up-down directional ends of the outer wall part 11a.

The upper and lower outer flanges 11d respectively extend in the up-down direction from vehicle-widthwise inner edge parts of the upper and lower wall parts 11b and 11c.

Such an outer frame 11 is joined to the inner frame 10 with the upper and lower outer flanges 11d being in abutment respectively with the upper and lower inner flanges 10d.

Thus, the side sill 3 has a hollow substantially rectangular cross-sectional shape.

Such a side sill 3 includes a reinforcing member 28 disposed in the internal space thereof. The reinforcing member 28 has, for example, a rectangular parallelepiped shape extending in the vehicle body front-rear direction along an inner surface of the inner wall part 10a and an inner surface of the outer wall part 11a. The reinforcing member 28 is joined, on its vehicle-widthwise opposite sides, in abutment to the inner surface of the inner wall part 10a and the inner surface of the outer wall part 11a.

Furthermore, the reinforcing member 28 includes a reinforcing part 28a in the inside thereof.

The reinforcing part 28a includes, for example, flat plates coupled in a lattice shape.

At the time of a side collision of the vehicle 1, such a reinforcing member 28 can reinforce rigidity of the side sill 3 and also absorb impact energy.

The reinforcing member 28 is, for example, an aluminum extrusion molded product.

For example, as illustrated in FIG. 3, the battery frame 4 is disposed at a predetermined interval at a position facing a bottom surface side of the floor panel 6.

The battery frame 4 is also disposed on a vehicle-widthwise inner side of the side sill 3.

The battery frame 4 includes, for example, frame members 4a and a bottom plate 4b.

The frame members 4a form a rectangular frame as a whole. Each frame member 4a has a rectangular cross-sectional shape.

The bottom plate 4b is disposed on a bottom surface of a rectangular frame formed by the frame members 4a. Thus, the bottom plate 4b has a rectangular shape in plan view. For example, an outer peripheral edge part of the bottom plate 4b is bent upward along an outer edge part of a lower end part of each frame member 4a. A vehicle-widthwise outer surface of the bent outer peripheral edge part is joined to a lower part of the inner wall part 10a.

A battery case 7 can be placed on an upper surface of each frame member 4a and an upper surface of the bottom plate 4b of such a battery frame 4.

The battery case 7 includes an upper case 16 and a lower case 17.

Each of the upper and lower cases 16 and 17 is, for example, formed by pressing a sheet metal member made of a steel plate or the like. Each of the upper and lower cases 16 and 17 has, for example, a substantially hat-shaped cross-sectional shape. Thus, an outward flange part 16a and an outward flange part 17a are respectively formed at outer peripheral edge parts of the upper and lower cases 16 and 17.

Such upper and lower cases 16 and 17 are joined to each other with their opening parts facing each other and with the outward flange parts 16a and 17a being in abutment with each other. Thus, the battery case 7 has a hollow substantially rectangular cross-sectional shape.

Such a battery case 7 houses the battery 9 in the internal space thereof.

The battery 9 is, for example, a battery that supplies electric power to a motor that is a drive source of the vehicle. Such a battery 9 includes rectangular parallelepiped-shaped battery cells (not illustrated) stacked together. The battery cells each accommodate electric cells of a secondary battery including a lithium ion battery, a nickel hydrogen battery, or the like.

The battery case 7 housing such a battery 9 is joined to each frame member 4a in a state of being placed on the battery frame 4. Thus, the battery 9 is fixed at a position facing the vehicle-widthwise inner side of the side sill 3.

As illustrated in FIG. 2, the side door 5 is, for example, a swing door swingable in the vehicle width direction of the vehicle body 2. Thus, a front part of the side door 5 is supported at a front part of a door opening part 20 via upper and lower hinges (not illustrated). The side door 5 is configured to cover the vehicle-widthwise outer side of the side sill 3 when closing the door opening part 20. That is, the lower part of the side door 5 is positioned to face the vehicle-widthwise outer side of the side sill 3.

As illustrated in FIGS. 2 to 4, such a side door 5 includes an inner panel 30 and an outer panel 31. In the following description, the disposition of each component of the side door 5 is disposition in a state where the side door 5 closes the door opening part 20.

The inner panel 30 is formed by pressing a sheet metal member made of a steel plate or the like. The inner panel 30 is disposed on a vehicle-widthwise inner side of the side door 5. A lower part of the inner panel 30 is disposed to cover the outer wall part 11a of the side sill 3.

In one detailed example, the inner panel 30 includes a first side wall part 30a, a second side wall part 30b, and a lower wall part 30c.

The first side wall part 30a forms a vehicle-widthwise inner side wall part of the side door 5 mainly above the side sill 3.

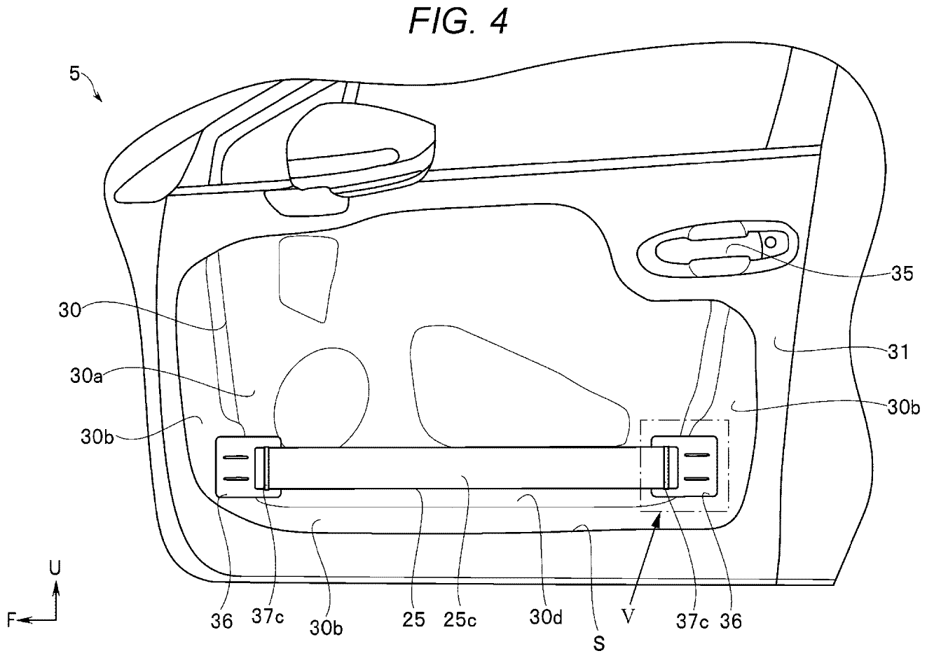

The second side wall part 30b is formed so as to be continuous with a front-rear edge part and a lower edge part of the first side wall part 30a with a stepped part 30d interposed therebetween. The stepped part 30d extends vehicle-widthwise outward from a lower end part of the first side wall part 30a. Consequently, the second side wall part 30b is disposed outside in the vehicle width direction with respect to the first side wall part 30a. As illustrated in FIG. 4, vehicle body front-rear directional ends of the second side wall part 30b serve as attachments of an impact absorbing member 25 to be described later.

Here, the second side wall part 30b has a lower region disposed at a position lower than the first side wall part 30a and at a position facing the side sill 3. As described above, the provision of the lower region of the second side wall part 30b at the position facing the side sill 3 allows avoidance of interference between the inner panel 30 and the side sill 3 in a state where the side door 5 closes the door opening part 20.

The lower wall part 30c extends vehicle-widthwise outward from a lower end part of the second side wall part 30b. The lower wall part 30c is formed at a height at which the lower wall part 30c substantially matches the lower wall parts 10c and 11c of the side sill 3.

The lower wall part 30c thus formed has a drain hole 32 at a substantially central part thereof in the vehicle width direction. The drain hole 32 is disposed for draining, to the outside of the vehicle, rainwater or the like entering the internal space of the side door 5 from the outside of the vehicle. Drain holes 32 are disposed in the vehicle body front-rear direction of the side door 5.

An outward flange part 30e extending in a state of being bent downward is formed at a vehicle-widthwise outer edge part of such a lower wall part 30c. The outward flange part 30e forms a front edge part, a rear edge part, and a lower edge part of the inner panel 30.

On a vehicle-widthwise inner side of the inner panel 30 thus formed, a resin trim panel 33 protruding vehicle-widthwise inward from the first side wall part 30a is disposed.

The outer panel 31 is formed by pressing a sheet metal member made of a steel plate or the like. The outer panel 31 is disposed on a vehicle-widthwise outer side of the side door 5. A front edge part, a rear edge part, and a lower edge part of the outer panel 31 are joined to the outward flange part 30e of the inner panel 30 by hemming or the like.

Through such joining of the inner panel 30 and the outer panel 31, the side door 5 has an internal space.

Upper edge parts of the inner panel 30 and the outer panel 31 face each other and are bent toward the inside of the side door 5. An upper surface of the side door 5 has an opening part (not illustrated) through which a window glass 34 enters and exits.

Furthermore, a door handle 35 is attached to the outer panel 31 near the rear part on the outer surface side of the outer panel 31. The door handle 35 is coupled, inside the side door 5, to a ratchet mechanism via a rod (neither is illustrated).

Here, as illustrated in FIG. 3, in the lower part of the side door 5, the second side wall part 30b of the inner panel 30 faces the outer panel 31. On the other hand, in an upper part of the side door 5, the first side wall part 30a faces the outer panel 31. Thus, a vehicle-widthwise interval of the lower part of the side door 5 is set to be smaller than a vehicle-widthwise interval of the upper part of the side door 5. However, an interval between the second side wall part 30b and the outer panel 31 in the lower part of the side door 5 is set to a dimension such that at least rainwater or the like that has entered the inside of the side door 5 can be drained to the outside of the vehicle.

The impact absorbing member 25 is disposed in the internal space of the side door 5 thus configured. The impact absorbing member 25 absorbs impact energy upon a side collision of the vehicle 1.

The impact absorbing member 25 has a rectangular parallelepiped shape extending in the vehicle body front-rear direction.

In one detailed example, the impact absorbing member 25 includes an upper wall part 25a, a lower wall part 25b, an outer wall part 25c, and an inner wall part 25d.

The upper wall part 25a and the lower wall part 25b face each other at a predetermined interval in the up-down direction.

The outer wall part 25c and the inner wall part 25d face each other at a predetermined interval in the vehicle width direction.

Upper end parts of the outer wall part 25c and the inner wall part 25d are coupled to each other by the upper wall part 25a. Lower end parts of the outer wall part 25c and the inner wall part 25d are coupled to each other by the lower wall part 25b.

Consequently, the upper wall part 25a, the lower wall part 25b, the outer wall part 25c, and the inner wall part 25d form a hollow rectangular cross-sectional shape.

The impact absorbing member 25 thus formed includes reinforcing plates 25e in the internal space thereof. The reinforcing plates 25e each have, for example, a flat plate shape extending in the vehicle width direction.

For example, the reinforcing plates 25e (e.g., two in the present embodiment) are disposed so as to partition the internal space of the impact absorbing member 25 in the vehicle body up-down direction.

Such reinforcing plates 25e can reinforce rigidity of the impact absorbing member 25 at the time of a side collision of the vehicle 1. Additionally, the reinforcing plates 25e can be deformed together with the impact absorbing member 25 to absorb impact energy at the time of the side collision of the vehicle 1. In order to accurately absorb the impact energy, various conditions such as the plate thickness of the reinforcing plate 25e and the number of the reinforcing plates 25e disposed inside the impact absorbing member 25 are determined in advance from experiments, simulations, and the like. Furthermore, the reinforcing plates 25e may be disposed inside the impact absorbing member 25 in a lattice shape. The impact absorbing member 25 including these reinforcing plates 25e inside is, for example, an aluminum extrusion molded product.

Such an impact absorbing member 25 reinforces rigidity of the side sill 3 at the time of a side collision of the vehicle 1. However, before a side collision of the vehicle 1 occurs, the impact absorbing member 25 is fixed to the inner panel 30 at a position higher than the position facing the side sill 3.

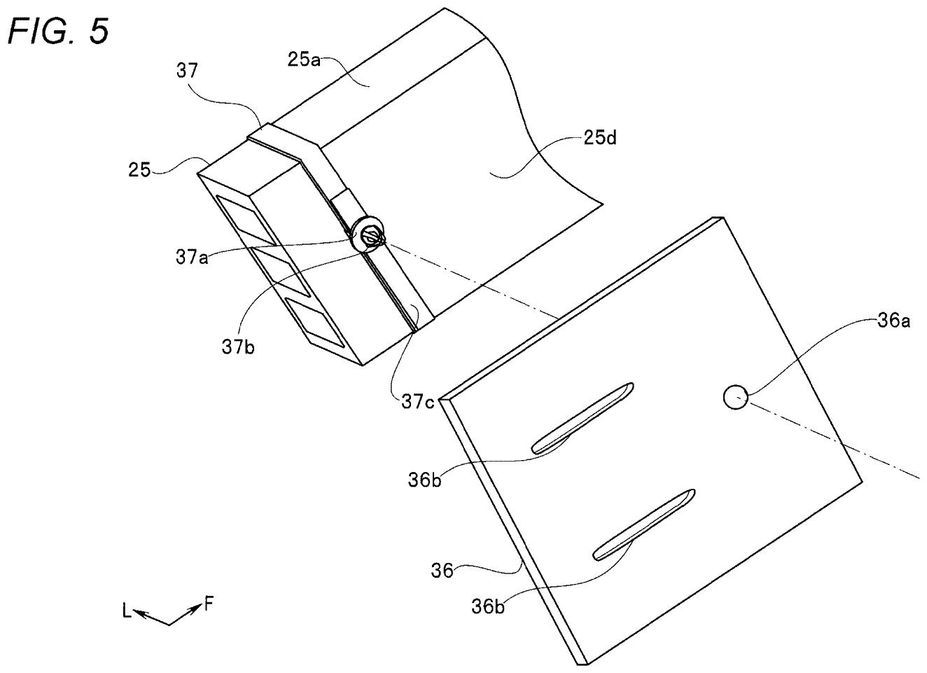

In one example, both ends of the impact absorbing member 25 are respectively fixed to front and rear brackets 36 as illustrated in FIGS. 4 and 5.

The front and rear brackets 36 each have, for example, a flat plate shape having reinforcing parts 36b. The front and rear brackets 36 are each formed of a sheet metal member made of a steel plate or the like. The front and rear brackets 36 are respectively joined, from the vehicle-widthwise outside, in abutment to front and rear parts of the second side wall part 30b. Such front and rear brackets 36 each include a lock hole 36a.

The front and rear ends of the impact absorbing member 25 are respectively fixed to such front and rear brackets 36 using clips 37 as fixing members.

Each of the clips 37 is, for example, a clip with a band. That is, as illustrated in FIG. 5, the clip 37 integrally includes a clip body 37a and a band part 37c. Such a clip 37 is, for example, a resin member.

The clip body 37a has a function of fixing the clip 37 to the bracket 36. Thus, the clip body 37a includes a lock part 37b.

The lock part 37b has a rhombus shape in side view. The lock part 37b is pushed into the lock hole 36a and thus locked to the lock hole 36a. In this state, the clip body 37a is fixed to each bracket 36 by adhesion.

The band part 37c is wound around the outer periphery near the end of the impact absorbing member 25. The band part 37c is fixed to the outer periphery of the impact absorbing member 25 by tightening. Such a band part 37c is set to have a fixing strength at which the fixing of both ends of the impact absorbing member 25 is released upon input of an impact load F greater than or equal to a predetermined load to the impact absorbing member 25.

For example, upon input of the impact load F greater than or equal to the predetermined load to the impact absorbing member 25, the band part 37c causes a shift in the winding position with respect to the impact absorbing member 25. Using such a shift, the band part 37c can release the impact absorbing member 25.

In order to accurately release the impact absorbing member 25 upon input of the impact load F greater than or equal to the predetermined load to the impact absorbing member 25, various conditions such as the strength of the band part 37c, the thickness of the band part 37c, and the tightening force of the band part 37c are determined in advance from experiments, simulations, and the like.

As illustrated in FIGS. 3 and 4, the impact absorbing member 25 thus fixed to the inner panel 30 is disposed above a space S in the lower region of the side door 5 defined by the second side wall part 30b and the outer panel 31. Here, in the present embodiment, the lower region of the side door 5 refers to a region facing the side sill 3 in the state where the side door 5 closes the door opening part 20. That is, the lower region of the side door 5 is a region covering the side sill 3. Thus, the interval between the inner panel 30 and the outer panel 31 is narrower in the lower region of the side door 5 than in an upper region of the side door 5 in order to avoid interference with the side sill 3.

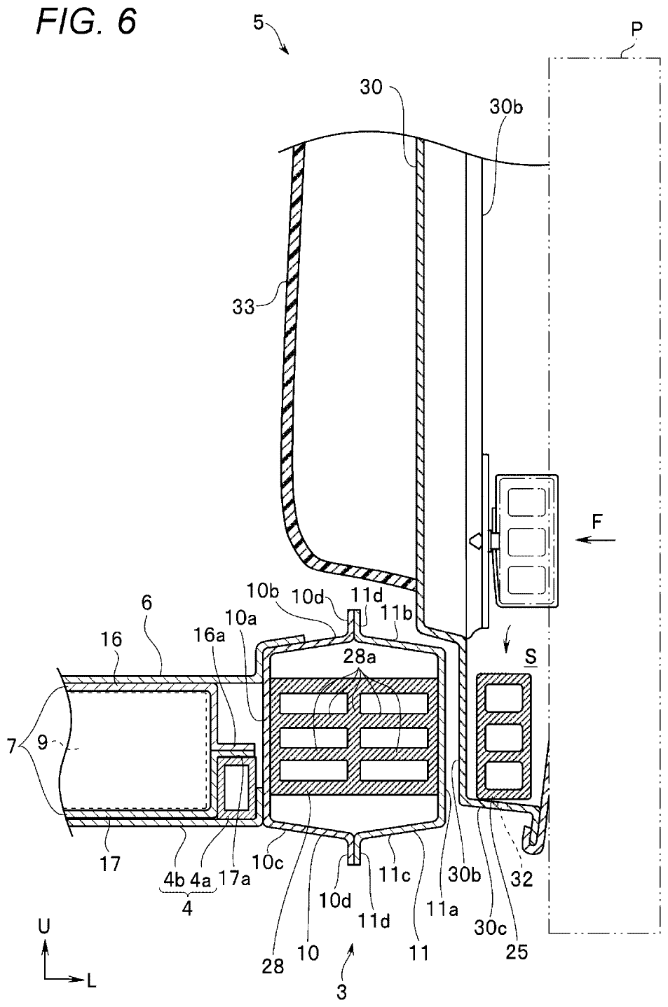

As illustrated in FIG. 6, at the time of a side collision of the vehicle 1, the impact absorbing member 25 thus disposed is released from the band part 37c upon input of the impact load F greater than or equal to the predetermined load to the side door 5. Then, the impact absorbing member 25 falls into the space S in the lower region of the side door 5. That is, the impact absorbing member 25 is fixed at the position of the inner panel 30 where the impact absorbing member 25 can fall into the space S.

Here, the width between the second side wall part 30b and the outer panel 31 that define the space S is set to be larger than a vehicle-widthwise width of the impact absorbing member 25 (vehicle-widthwise dimension between the upper wall part 25a and the lower wall part 25b). This allows the fallen impact absorbing member 25 to be accurately accommodated in the space S.

In one example, the impact absorbing member 25 that has fallen into the space S is accommodated in the space S in a state where the lower wall part 25b of the impact absorbing member 25 is in abutment with the lower wall part 30c of the inner panel 30.

Consequently, the impact absorbing member 25 reinforces the rigidity of the side sill 3 at the position facing the side sill 3.

As described above, in the present embodiment, the clip 37 corresponds to a specific example as a fixing member.

According to such an embodiment, the side door structure includes the inner panel 30, the outer panel 31, the drain hole 32, the impact absorbing member 25, and the clip 37. The inner panel 30 covers the vehicle-widthwise outer side of the side sill 3 extending in the vehicle body front-rear direction. The outer panel 31 is disposed at the position facing the inner panel 30 and joined, at the edge part of the outer panel 31, to the inner panel 30 to constitute the side door 5 together with the inner panel 30. The drain hole 32 is provided in the lower end part of the inner panel 30. The drain hole 32 allows rainwater entering the internal space of the side door 5 from the outside of the vehicle to drain. The impact absorbing member 25 is disposed in the internal space of the side door 5. The impact absorbing member 25 extends in the vehicle body front-rear direction. The clip 37 fixes the impact absorbing member 25 to the inner panel 30 at the position higher than the position facing the side sill 3. The clip 37 fixes the impact absorbing member 25 to the inner panel 30 at the fixing strength at which the impact absorbing member 25 is releasable upon input of the impact load F greater than or equal to the predetermined load to the side door 5.

These configurations can provide adequate rigidity reinforcement to the side sill 3 without impairing drainage of rainwater or the like entering the inside of the door from the outside of the vehicle, although the impact absorbing member 25 is disposed inside the side door 5.

That is, the side door 5 includes the impact absorbing member 25 at the position higher than the position facing the side sill 3 in the internal space of the side door 5. Consequently, the side door 5 can prevent deterioration in drainage of rainwater or the like as compared with a case where the impact absorbing member 25 is typically disposed in the lower region of the side door 5 facing the side sill 3. Thus, although the impact absorbing member 25 is disposed inside the side door 5, the side door 5 allows rainwater or the like that has entered the inside of the side door 5 to be quickly guided to the drain hole 32 without interfering with the flow of rainwater or the like.

Additionally, the impact absorbing member 25 is fixed to the inner panel 30 by the clips 37 at the position higher than the position facing the side sill 3. The clips 37 are each set to have a fixing strength at which the impact absorbing member 25 is released upon input of the impact load F greater than or equal to the predetermined load to the side door 5. Consequently, the clips 37 can accurately drop the impact absorbing member 25 upon input of the impact load F greater than or equal to the predetermined load to the side door 5. Thus, setting the position where the impact absorbing member 25 falls into the space S in the lower region facing the side sill 3 can accurately reinforce the rigidity of the side sill 3, although the impact absorbing member 25 is fixed to the position higher than the position facing the side sill 3.

The fall of the impact absorbing member 25 into the space S in the lower region is limited to the case where the impact load F greater than or equal to the predetermined load is input to the side door 5. Thus, the impact absorbing member 25 can be set even in a shape in which the interval between the impact absorbing member 25 and the outer panel 31 is markedly narrow when the impact absorbing member 25 falls into the space S in the lower region. Consequently, the shape of the impact absorbing member 25 can be set with high flexibility as compared with the case where the impact absorbing member 25 is typically disposed in the lower region of the side door 5. Thus, although the impact absorbing member 25 is disposed inside the side door 5, the shape of the impact absorbing member 25 can be set to an optimum shape for reinforcing the rigidity of the side sill 3.

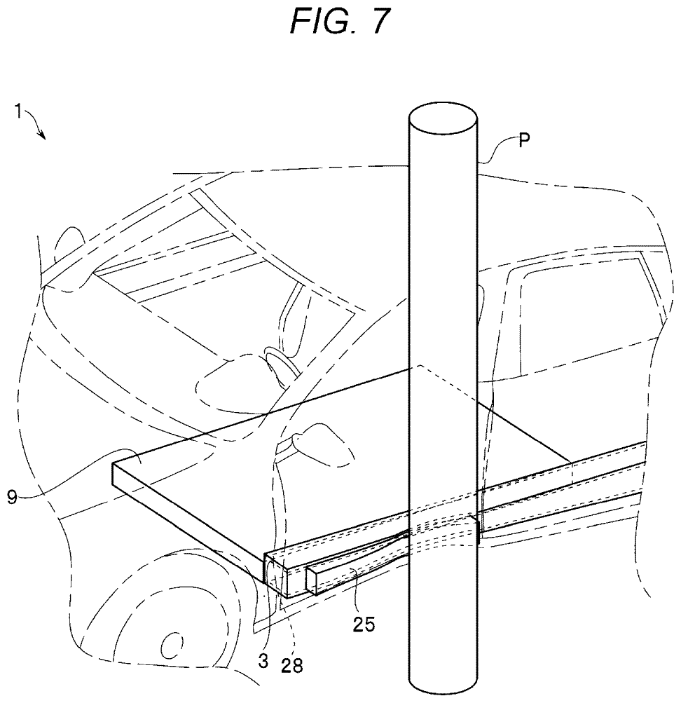

Consequently, for example, upon a pole side collision in which a collision load from a utility pole or the like (pole P) is locally concentrated and input to the side surface of the vehicle 1, when the impact load F greater than or equal to the predetermined load is input to the side door 5, the impact absorbing member 25 can accurately absorb impact energy at an initial stage of the collision. As a result, a deformation stroke of the side sill 3 can be reduced (see FIG. 7).

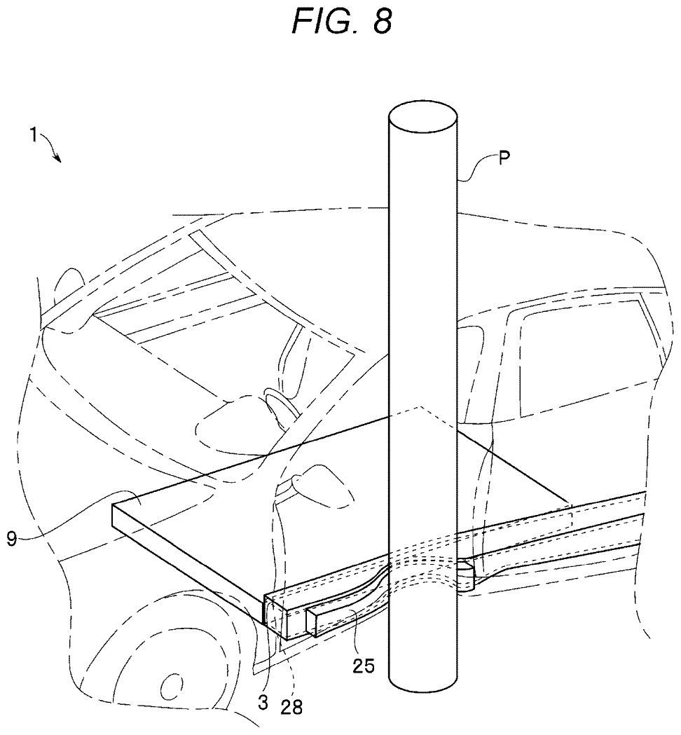

Furthermore, since the deformation stroke of the side sill 3 at the initial stage of the collision is reduced, the side sill 3 can accurately absorb impact energy at a final stage of the collision without greatly deforming vehicle-widthwise inward (see FIG. 8). Thus, for example, even when the battery 9 is mounted under the floor of the vehicle 1, the battery 9 can be accurately protected from the pole side collision or the like.

In this case, forming the impact absorbing member 25 into a substantially rectangular cross-sectional shape can effectively enhance the rigidity of the impact absorbing member 25.

Additionally, the provision of the reinforcing plates 25e inside the impact absorbing member 25 can further enhance the impact absorption efficiency of the impact absorbing member 25.

Furthermore, the present embodiment has described an example in which the impact absorbing member 25 is fixed to the brackets 36 by the clips 37 and joined to the inner panel 30 via the brackets 36. However, the brackets 36 may be omitted. For example, the clips 37 to which both ends of the impact absorbing member 25 are fixed may be joined to the inner panel 30 by adhesion or the like in a state of being engaged with the inner panel 30.

Furthermore, the release of the impact absorbing member 25 performed by the clips 37 is not limited to using the shift in the winding position of the band part 37c. For example, the release of the impact absorbing member 25 performed by the clips 37 may be a release using the breakage of the band part 37c or the fall-off of the clip body 37a from the lock hole 36a.

The present embodiment has described the example in which the impact absorbing member 25 is applied to the front side door 5 of the vehicle 1. However, the impact absorbing member 25 can also be applied to a rear side door of the vehicle 1.

In recent years, a hybrid vehicle including an electric motor as a drive source in addition to a conventional internal combustion engine (engine), an electric vehicle including an electric motor as a drive source, and the like have been put into practical use in a vehicle such as an automobile.

Such a vehicle has a large rechargeable battery (hereinafter, simply abbreviated as a battery) mounted therein for driving an electric motor. Such a large battery is typically disposed on a bottom surface part of a floor panel. Additionally, side sills extending in a vehicle body front-rear direction are disposed on vehicle-widthwise opposite sides of the battery.

The side sills each have a closed cross-sectional shape in a substantially rectangular cross-section. Such side sills serve as impact absorbers that absorb impact energy and protect the battery at the time of a side collision of the vehicle.

Incidentally, part of vehicle-widthwise outer surfaces of the side sills is typically exposed to the outside of the vehicle. Dirt easily adheres to such surfaces of the side sills, which are exposed to the outside of the vehicle.

In recent years, in order to prevent such dirt from adhering to the side sills, side doors have been adopted that cover the vehicle-widthwise outer surfaces of the side sills.

The adoption of such side doors in the above-described vehicle involves a problem that spaces for disposition of the side sills are reduced, and adequate absorption of impact energy cannot be secured at the time of a side collision of the vehicle.

In response to such a problem, for example, Japanese Unexamined Patent Application Publication (JP-A) No. 2019-25935 describes a technique related to a side door structure in which an impact absorbing member is disposed in the inside of a side door and an amount of absorption of impact energy at the time of a side collision of a vehicle can be increased.

However, an outer panel and an inner panel constituting the side door are typically joined, at a lower edge part of the side door, to each other by hemming. Thus, in a lower part of the side door, an interval between the outer panel and the inner panel is narrow.

When the impact absorbing member is disposed in a space having such a narrow interval, a shape of the impact absorbing member is limited. For example, in the technique of JP-A No. 2019-25935, the impact absorbing member has an inclined lower wall part, thereby avoiding interference between the impact absorbing member and the outer panel. Thus, in the technique of JP-A No. 2019-25935, the impact absorbing member may not be able to adequately secure a function of reinforcing rigidity of the side sill.

On the other hand, when the impact absorbing member has no inclined lower wall part, the interval between the outer panel and the impact absorbing member is markedly narrow. This may result in deteriorated drainage of rainwater or the like entering the inside of the door from the outside of the vehicle.

It is desirable to provide a side door structure capable of providing adequate rigidity reinforcement to a side sill without impairing drainage of rainwater or the like entering the inside of a door from the outside of a vehicle, although an impact absorbing member is disposed inside a side door.

An aspect of the disclosure provides a side door structure. The side door structure includes an inner panel, an outer panel, a drain hole, an impact absorbing member, and a fixing member. The inner panel covers a vehicle-widthwise outer side of a side sill extending in a vehicle body front-rear direction that is a front-rear direction of a vehicle body of a vehicle. The outer panel is disposed at a position facing the inner panel and joined, at an edge part of the outer panel, to the inner panel to constitute a side door of the vehicle together with the inner panel. The drain hole is provided in a lower end part of the inner panel. The drain hole is formed to drain rainwater entering an internal space of the side door from an outside of the vehicle. The impact absorbing member is disposed in an internal space of the side door. The impact absorbing member extends in the vehicle body front-rear direction. The fixing member fixes the impact absorbing member to the inner panel at a position higher than a position facing the side sill. The fixing member fixes the impact absorbing member to the inner panel at a fixing strength at which the impact absorbing member is releasable upon input of an impact load greater than or equal to a predetermined load to the side door.

Obviously, numerous modifications and variations of the present invention are possible in light of the above teachings. It is therefore to be understood that within the scope of the appended claims, the invention may be practiced otherwise than as specifically described herein.

1. A side door structure, comprising:
an inner panel covering a vehicle-widthwise outer side of a side sill extending in a vehicle body front-rear direction of a vehicle;
an outer panel joined to the inner panel at an edge part of the outer panel and constituting a side door of the vehicle together with the inner panel;
an impact absorbing member disposed in an internal space of the side door and extending in the vehicle body front-rear direction; and
a fixing member fixing the impact absorbing member to the inner panel at a position higher than a position facing the side sill,
wherein the inner panel has a drain hole formed in a lower end part of the inner panel and configured to drain rainwater entering the internal space of the side door from an outside of the vehicle, and the fixing member fixes the impact absorbing member to the inner panel at a fixing strength at which the impact absorbing member is releasable upon input of an impact load greater than or equal to a predetermined load to the side door.

2. The side door structure according to claim 1, wherein the impact absorbing member has a substantially rectangular cross-sectional shape.

3. The side door structure according to claim 1, wherein the impact absorbing member comprises a reinforcing plate inside of the impact absorbing member.

4. The side door structure according to claim 1, wherein the fixing member fixes the impact absorbing member to the inner panel at a position where the impact absorbing member is allowed to fall into a space in a lower region of the side door facing the side sill.

5. The side door structure according to claim 1, wherein in the vehicle to which the side door structure is applied, a battery is mounted on a vehicle-widthwise inner side of the side sill.

6. The side door structure according to claim 2, wherein the impact absorbing member comprises a reinforcing plate inside of the impact absorbing member.

7. The side door structure according to claim 2, wherein the fixing member fixes the impact absorbing member to the inner panel at a position where the impact absorbing member is allowed to fall into a space in a lower region of the side door facing the side sill.

8. The side door structure according to claim 2, wherein in the vehicle to which the side door structure is applied, a battery is mounted on a vehicle-widthwise inner side of the side sill.

9. The side door structure according to claim 3, wherein the fixing member fixes the impact absorbing member to the inner panel at a position where the impact absorbing member is allowed to fall into a space in a lower region of the side door facing the side sill.

10. The side door structure according to claim 3, wherein in the vehicle to which the side door structure is applied, a battery is mounted on a vehicle-widthwise inner side of the side sill.

11. The side door structure according to claim 4, wherein in the vehicle to which the side door structure is applied, a battery is mounted on a vehicle-widthwise inner side of the side sill.
